(19) United States
(12) Patent Application Publication
(10) Pub. No.: US 2019/0322914 A1
(43) Pub. Date: Oct. 24, 2019

(54) TWO COMPONENT POLYURETHANE COMPOSITION

(71) Applicant: SIKA TECHNOLOGY AG, Baar (CH)

(72) Inventor: Steffen KELCH, Oberengstringen (CH)

(73) Assignee: SIKA TECHNOLOGY AG, Baar (CH)

(21) Appl. No.: 16/470,615

(22) PCT Filed: Dec. 20, 2017
(86) PCT No.: PCT/EP2017/083835

§ 371 Date: Jun. 18, 2019

(30) Foreign Application Priority Data
Dec. 23, 2016 (EP) 16206583.3

(51) Int. Cl. C09J 175/08; C09J 5/00; C08G 18/64; C08G 18/48; C08G 18/62; C08G 18/40; C08G 18/32; C08G 18/66; C08G 18/73

(52) U.S. Cl. CPC C09J 175/08; C09J 5/00; C08G 18/64; C08G 18/4829; C09J 2475/00; C08G 18/4081; C08G 18/3206; C08G 18/6674; C08G 18/73; C08G 18/6208

(57) ABSTRACT

A two-component polyurethane composition including of a polyol component and a polyisocyanate component, wherein the polyol component includes at least one reaction product of castor oil with ketone resins A1, at least one aliphatic triol A2, preferably an aliphatic diol A3, a polybutadiene polyol A4 and at least one hydroxylated polyester polyol A5 based on tall oil. The polyurethane composition has high strength and only a minor dependence of mechanical properties, especially of strength, on temperature. Moreover, the composition is capable of curing without blistering under ambient conditions, even in the presence of substrates that typically promote foaming reactions owing to the presence of residual moisture, for example glass fiber weave.

### TECHNICAL FIELD

The invention relates to the field of two-component polyurethane compositions and to the use thereof, especially as adhesive.

### PRIOR ART

Two-component polyurethane adhesives based on polyols and polyisocyanates have already been used for some time. Two-component polyurethane adhesives have the advantage that they cure rapidly after mixing and can therefore absorb and transmit higher forces even after a short time. For use as structural adhesives, high demands in relation to strength are made, since such adhesives are elements of load-bearing structures.

More particularly, there is a desire for adhesives that have/assure high strengths for the purposes of structural bonds over a maximum temperature range, especially in the range from −60° C. to above +50° C., combined with a comparatively minor dependence of strength on temperature. What are also desired are adhesives that cure without foaming reaction under ambient conditions, including in the case of substrates such as glass fiber weaves that promote foaming reactions, for example owing to their affinity to adsorb air humidity.

### SUMMARY OF THE INVENTION

It is therefore an object of the present invention to provide a two-component polyurethane composition that has high strength and only a minor dependence of mechanical properties, especially strength, on temperature, especially in the range from −60° C. to +50° C. Moreover, the composition should cure under ambient conditions without foam formation owing to a reaction of isocyanate groups with moisture, even in the case of substrates that typically promote foaming reactions owing to presence of residual moisture.

This object is surprisingly achieved by the two-component polyurethane composition of the invention. The composition has high tensile strength and high moduli of elasticity with only a minor dependence of mechanical properties, especially tensile strength and moduli of elasticity, on temperature.

Moreover, the composition is particularly resistant to foaming due to absorption of air humidity or due to remaining residual moisture in the polyol component and/or the substrates, for example in the case of glass fiber weaves.

Moreover, it has been found that, surprisingly, the compositions of the invention have a first glass transition temperature (Tg1) at temperatures of approximately −60° C. and a second, dominant glass transition temperature (Tg2) at temperatures above +50° C., especially above +70° C., especially above +90° C. This has the advantage of constant mechanical properties over a broad temperature range of interest for application purposes.

It was additionally found that the mechanical properties after curing at room temperature do not differ from the mechanical properties that are achieved on curing at elevated temperature, i.e. a heat treatment process (3 h at 80° C.). This, especially together with the finding of insensitivity with respect to foaming reactions, means that the composition is of particular interest for the production of fiber composites. In this way, it is firstly possible to dispense with predrying and pretreatment of the fibers and secondly with curing at elevated temperature/heat treatment process on the fiber composite material, which constitutes a great advantage in terms of process technology.

Further aspects of the invention are the subject of further independent claims. Particularly preferred embodiments of the invention are the subject of the dependent claims.

### WAYS OF EXECUTING THE INVENTION

The present invention relates to a two-component polyurethane composition consisting of a polyol component K1 and a polyisocyanate component K2;

wherein the polyol component K1 comprises
at least one reaction product of castor oil with ketone resins having
an OH number of 110 to 200 mg KOH/g A1; and
at least one aliphatic triol having an average molecular weight of 170-500 g/mol and an OH number of 400-1100 mg KOH/g, which is polyether polyols based on 1,1,1-trimethylolpropane A2; and preferably at least one aliphatic diol having a molecular weight of 90-146 g/mol A3; and
at least one polybutadiene polyol having an average OH functionality of 2.1 to 2.9, especially 2.3 to 2.7, and having an average molecular weight in the range from 2000 to 4000 g/mol, especially 2500 to 3000 g/mol, and an OH number of 40-100 A4; and
at least one hydroxylated polyester polyol A5 based on tall oil;
and wherein the polyisocyanate component K2 comprises
at least one aromatic polyisocyanate B1.
The ratio of the OH groups of (A1+A4+A5)/(A2+A3) is from 0.25-5 and the ratio of all NCO groups of the aromatic polyisocyanates B1:all OH groups of the polyol component K1 is 0.95:1 to 1.25:1.

The prefix “poly” in substance names such as “polyol”, “polyisocyanate”, “polyether” or “polyamine” in the present document indicates that the respective substance, in a formal sense, contains more than one of the functional groups that occur in its name per molecule.

In the present document, “molecular weight” is understood to mean the molar mass (in grams per mole) of a molecule. “Average molecular weight” refers to the number-average molecular weight Mₙ of a polydisperse mixture of oligomeric or polymeric molecules, which is typically determined by means of GPC against polystyrene as standard.

A “primary hydroxyl group” refers to an OH group bonded to a carbon atom having two hydrogens.

“Open time” in this document refers to the time within which the parts to be bonded have to be joined after the components have been mixed.

The term “strength” in the present document refers to the strength of the cured adhesive, and strength especially means the tensile strength and modulus of elasticity, especially within the expansion range of 0.05% to 0.25%.

In the present document, “room temperature” refers to a temperature of 23° C.

In the present document, glass transition temperature (also abbreviated hereinafter to Tg) is determined by the method as described in the examples section.

The polyol component K1 comprises at least one reaction product of castor oil with ketone resins having an OH number of 110 to 200 mg KOH/g A1.

Preference is given to an OH number of 155 to 190 mg, especially 140 to 170 mg, especially preferably 150-160 mg KOH/g. It preferably has an OH equivalent weight of 300 to 400 g/eq.

Particular preference is given to reaction products of castor oil with ketone resins based on cyclohexanone, especially those as sold, for example, by Nuplex Resins GmbH, Germany under the Setathane® 1150 name and by BASF, Germany under the Sovermol® 805 name.

In the present document, the term “castor oil” is especially understood to mean castor oil as described in CD Römpp Chemie Lexikon [Römpp's Chemical Lexicon on CD], Version 1.0, Thieme Verlag.

In the present document, the term “ketone resin” is especially understood to mean ketone resin as described in CD Römpp Chemie Lexikon, Version 1.0, Thieme Verlag.

The polyol component K1 comprises at least one aliphatic triol having an average molecular weight of 170-500 g/mol and an OH number of 400-1100 mg KOH/g, which is polyether polyols based on 1,1,1-trimethylolpropane A2.

Preferably, the aliphatic triol A2 is polyether polyols based on 1,1,1-trimethylolpropane having an average molecular weight of 175-400 g/mol, especially of 175-350 g/mol. It is further advantageous when the aliphatic triol A2 has an OH number of 500-1000 mg KOH/g, preferably 520-980 mg KOH/g.

Preferably, the polyether polyols based on 1,1,1-trimethylolpropane are alkoxylated 1,1,1-trimethylolpropane, especially ethoxylated or propoxylated 1,1,1-trimethylolpropane, most preferably propoxylated 1,1,1-trimethylolpropane.

Suitable polyether polyols based on 1,1,1-trimethylolpropane are also commercially available, for example, under the Desmophen® 4011 T trade name from Covestro AG, Germany or under the Lupranol® 3903 trade name from BASF, Germany.

The polyol component K1 preferably has at least one aliphatic diol having a molecular weight of 90-146 g/mol A3.

This leads to high values for tensile strength with simultaneously high values of the moduli of elasticity. Furthermore, this is advantageous in that particularly high values for the second, high Tg are obtained, especially above 90° C. In other words, particularly high values for the difference in temperature between the first and the second Tg are obtained, especially above 150 K.

Preferably, the at least one aliphatic diol A3 is selected from the list consisting of butane-1,4-diol, 2-ethylhexane-1,3-diol, 3-methyl pentane-1,5-diol and pentane-1,5-diol, preferably selected from the list consisting of butane-1,4-diol and pentane-1,5-diol. It is preferably butane-1,4-diol.

If the aliphatic diol A3 is butane-1,4-diol, this is advantageous in that, as a result, higher values for tensile strength, moduli of elasticity and gelation time and also a greater difference in temperature between the first and the second Tg are obtained.

The polyol component K1 comprises at least one polybutadiene polyol having an average OH functionality of 2.1 to 2.9, especially 2.3 to 2.7, and having an average molecular weight in the range from 2000 to 4000 g/mol, especially 2500 to 3000 g/mol, and an OH number of 40-100 A4.

Such polybutadiene polyols are especially obtainable by the polymerization of 1,3-butadiene and allyl alcohol in a suitable ratio or by the oxidation of suitable polybutadienes.

Suitable polybutadiene polyols are especially polybutadiene polyols that contain structural elements of the formula (I) and optionally structural elements of the formulae (II) and (III).

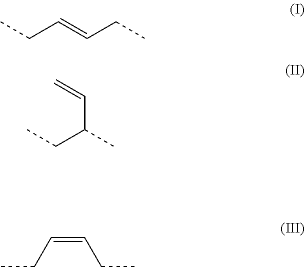

Preferred polybutadiene polyols contain

40% to 80%, especially 55% to 65%, of the structural element of the formula (I),
0% to 30%, especially 15% to 25%, of the structural element of the formula (II),
0% to 30%, especially 15% to 25%, of the structural element of the formula (III).

Particularly suitable polybutadiene polyols are available, for example, from Cray Valley, USA under the Poly bd® R-45HTLO or Poly bd® R-45M trade name or from Evonik, Germany under the Polyvest HT trade name.

The polyol component K1 comprises at least one hydroxylated tall oil-based polyester polyol A5. Preferably it is a hydroxylated, tall oil-based polyester diol.

With further preference it is a polyester polyol A5 having a hydroxyl number of 30-100, especially 60-90, more preferably 70-80.

Preferred hydroxylated, tall oil-based polyester diols are prepared by reacting tall oil with a dicarboxylic acid and/or the anhydride thereof and with a polyol having more than 3 OH groups.

The dicarboxylic acid and/or the anhydride thereof is preferably an aromatic dicarboxylic acid and/or the anhydride thereof, especially preferably phthalic anhydride.

The polyol having more than 3 OH groups is preferably a polyol having 3-8 OH groups, especially 3-4 OH groups, especially preferably a tetraol. With particular preference it is pentaerythritol.

The term “tall oil” refers in the present document preferably to a composition as defined under the heading “tall oil” in Römpp-Lexikon Chemie, 10^{th} edition, Georg Thieme Verlag, 1999.

Preferably the at least one hydroxylated, tall oil-based polyester polyol A5 is compositions having the CAS number 92128-24-0.

The hydroxylated, tall oil-based polyester polyols A5 preferably have a softening point below 23° C., preferably below 0° C., especially below −50° C. They also preferably have an acid number of 3-6 mg KOH/g.

With particular preference the composition in question is of the formula (IV)

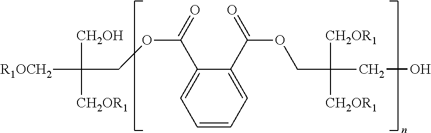

where R₁ is tall oil, particularly fatty acids of tall oil and the resin acids of tall oil, and the index “n” has a value of 1-4.

Particularly suitable polyester polyols A5 are available, for example, from Granel S.A., France under the REAGEM 5006 trade name.

The present polyisocyanate component K2 comprises at least one aromatic polyisocyanate B1.

Suitable aromatic polyisocyanates B1 are especially monomeric di- or triisocyanates, and oligomers, polymers and derivatives of monomeric di- or triisocyanates, and any mixtures thereof.

Suitable aromatic monomeric di- or triisocyanates are especially tolylene 2,4- and 2,6-diisocyanate and any mixtures of these isomers (TDI), diphenylmethane 4,4′-, 2,4′- and 2,2′-diisocyanate and any mixtures of these isomers (MDI), phenylene 1,3- and 1,4-diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI), dianisidine diisocyanate (DADI), 1,3,5-tris-(isocyanatomethyl)benzene, tris-(4-isocyanatophenyl)methane and tris(4-isocyanatophenyl) thiophosphate. Preferred aromatic monomeric di- or triisocyanates are derived from MDI and/or TDI, especially from MDI.

Suitable oligomers, polymers and derivatives of the monomeric di- and triisocyanates mentioned are especially derived from MDI and TDI. Especially suitable among these are commercially available grades, TDI oligomers such as Desmodur® IL (from Bayer); also suitable are room temperature liquid forms of MDI (called “modified MDI”), which are mixtures of MDI with MDI derivatives, such as, in particular, MDI carbodiimides or MDI uretonimines, known by trade names such as Desmodur® CD, Desmodur® PF, Desmodur® PC (all from Bayer), and mixtures of MDI and MDI homologs (polymeric MDI or PMDI), available under trade names such as Desmodur® VL, Desmodur® VL50, Desmodur® VL R10, Desmodur® VL R20, Desmodur® VH 20 N and Desmodur® VKS 20F (all from Bayer), Isonate® M 309, Voranate® M 229 and Voranate® M 580 (all from Dow) or Lupranat® M 10 R (from BASF). The aforementioned oligomeric polyisocyanates of this kind are typically mixtures of substances having different degrees of oligomerization and/or chemical structures. They preferably have an average NCO functionality of 2.1 to 4.0, preferably 2.1 to 3.0, especially 2.1 to 2.6.

Preferred aromatic polyisocyanates B1 are monomeric MDI or oligomers, polymers and derivatives derived from MDI, especially having an average NCO functionality of 2.0 to 4.0, preferably 2.0 to 3.0, especially 2.1 to 2.6.

Particularly advantageous are oligomers, polymers and derivatives derived from MDI, especially polymers derived from MDI, especially having an average NCO functionality of 2.1 to 2.6.

Where the species in question are oligomers, polymers and derivatives derived from MDI with an average NCO functionality of 2.4 to 2.6, it may be of advantage in that particularly high values are obtained for the temperature difference between the first and the second Tg. This is evident, for example, in a comparison of table 1 with table 3.

Where the species in question are oligomers, polymers and derivatives derived from MDI with an average NCO functionality of 2.1 to 2.3, this may be of advantage in that particularly high tensile strength values and modulus of elasticity values are obtained as a result. This is evident, for example, in a comparison of table 1 with table 3, where tensile strength values approximately twice as high and moduli of elasticity values of approximately three times as high are obtained.

More particularly the species in question are polymers derived from MDI, especially having a weight fraction of polymers derived from MDI of 20-90% by weight, based on the total weight of the aromatic polyisocyanate B1.

It is further advantageous when the aromatic polyisocyanate B1 has an average molecular weight of 160-2000 g/mol, especially 500-1500 g/mol.

It is further advantageous when the sum total of the NCO groups that do not originate from B1 is ≤5%, especially ≤2%, especially preferably ≤1%, most preferably ≤0.5%, based on the sum total of all NCO groups of the two-component polyurethane composition.

Preferably, the proportion of the aromatic polyisocyanurate B1 is ≥90% by weight, especially ≥95% by weight, especially preferably ≥99% by weight, based on the total weight of the polyisocyanate component K2.

The ratio of the OH groups of (A1+A4+A5)/(A2+A3) is from 0.25-5. Preferably, the ratio of the OH groups of (A1+A4+A5)/(A2+A3) is from 0.3-1.4, especially from 0.3-1.0, preferably from 0.3-0.8, especially preferably 0.3-0.6.

This leads to high values for tensile strength with simultaneously high values of the moduli of elasticity. Furthermore, this is advantageous in that particularly high values for the second Tg are obtained, especially above 90° C. In other words, particularly high values for the difference in temperature between the first and the second Tg are obtained, especially above 150 K.

It has also surprisingly been found that the values for the mechanical properties on curing for 7 days at room temperature are hardly different from those on curing for 3 h at 80° C.

At ratios of (A1+A4+A5)/(A2+A3) of less than 0.25, in particular, the open time is too short. Thus, for example, the gelation time in example E33, in spite of a small amount of catalyst, is already only 2 min.

At ratios of greater than 5, the resulting polyurethane compositions have values which are too low for tensile strength and for the moduli of elasticity.

The ratio of the OH groups of (A1+A2+A4+A5)/(A3) is preferably 0.4-5, especially 0.4-3, preferably 0.4-2, especially preferably 0.45-1.25.

This leads to high values in the tensile strength in conjunction with high values of the moduli of elasticity. This is also advantageous in that particularly high values for the 2nd Tg, in particular of more than 90° C., are obtained. Respectively, particularly high values are obtained for the temperature difference between the first and the second Tg, in particular of more than 150 K.

It has further surprisingly been found that the values for the mechanical properties on curing for 7 days at room temperature are hardly different from those on curing for 3 h at 80° C.

Where the aliphatic diol A3 is 1,4-butanediol and the aromatic polyisocyanate B1 comprises oligomers, polymers and derivatives derived from MDI derived from MDI with an average NCO functionality of 2.4 to 2.6, it can be advantageous if the ratio of the OH groups of (A1+A4+A5)/(A2+A3) is 0.3-1, especially 0.4-0.7, preferably 0.4-0.6.

This leads to high values in tensile strength in conjunction with high values of the moduli of elasticity. This is also advantageous in that particularly high values are obtained for the temperature difference between the first and the second Tg, in particular of more than 150 K.

It may further be advantageous if additionally the ratio of the OH groups of (A1+A2+A4+A5)/(A3) is 0.45-2, especially 0.6-1.25. This is apparent, for example, in table 1.

Where the aliphatic diol A3 is 1,4-butanediol and the aromatic polyisocyanate B1 comprises oligomers, polymers and derivatives derived from MDI derived from MDI with an average NCO functionality of 2.1 to 2.3, it can be advantageous if the ratio of the OH groups of (A1+A4+A5)/(A2+A3) is 0.25-4.6.

This leads to high values in the tensile strength in conjunction with high values of the moduli of elasticity and a sufficiently long gelation time. Moreover, this is of advantage in that particularly high values are obtained for the temperature difference between the first and the second Tg, in particular of more than 150 K.

It may further be advantageous if additionally the ratio of the OH groups of (A1+A2+A4+A5)/(A3) is 0.4-1.5, especially 0.45-0.9, preferably 0.45-0.7. This is apparent, for example, in table 3.

The ratio of the OH groups of (A1+A5)/(A4) is preferably 2-15, especially 3-10, more preferably 4-8.

This leads to high values in the tensile strength in conjunction with high values of the moduli of elasticity and high values for the temperature difference between the first and the second Tg. This is apparent, for example, from the comparison between the two reference examples R5 and R6.

If the ratio is below 2, a disadvantage is that low values of the tensile strength and of the modulus of elasticity are obtained as a result. If the ratio is more than 15, this leads to a low temperature difference between the first and the second Tg, in particular to the loss of two different Tg values and hence to a so-called mixed Tg.

The ratio of all NCO groups of the aromatic polyisocyanates B1:all OH groups of the polyol component K1 is 0.95:1-1.25:1. The ratio described above is understood to mean the molar ratio of the groups mentioned. Preferably, the ratio of all NCO groups of the aromatic polyisocyanates B1:all OH groups of the sum total of (A1+A2+A3+A4+A5)=0.95:1-1.25:1, especially 1.05:1-1.15:1.

In the two-component polyurethane composition, the sum total of all OH groups of (A1+A2+A3+A4+A5) is preferably ≥90% of the sum total of all OH groups of the two-component polyurethane composition.

Preferably, in the two-component polyurethane composition, the sum total of all OH groups of (A1+A2+A3+A4+A5) is ≥95%, especially ≥98%, especially preferably ≥99%, most preferably ≥99.5%, of the sum total of all OH groups of the two-component polyurethane composition. This is conducive to high values for tensile strength and modulus of elasticity.

Preferably, the two-component polyurethane composition is essentially free of OH groups that do not originate from (A1+A2+A3+A4+A5). The term “essentially free” is understood in this case to mean that the sum total of the OH groups that do not originate from (A1+A2+A3+A4+A5) is ≤5%, especially ≤2%, especially preferably ≤1%, most preferably ≤0.5%, based on the sum total of all OH groups of the two-component polyurethane composition. This is conducive to high values for tensile strength and modulus of elasticity.

Preferably, the two-component polyurethane composition is essentially free of OH groups of the following substances:
propane-1,2,3-triol and/or 1,1,1-trimethylolpropane
polyether polyols, especially polyoxyalkylene polyols, having an average molecular weight of 500 to 6000 g/mol.

In addition, the two-component polyurethane composition may contain catalysts that accelerate the reaction of hydroxyl groups with isocyanate groups, especially organotin, organozinc, organozirconium and organobismuth metal catalysts, for example dibutyltin dilaurate, or tertiary amines, amidines or guanidines, for example 1,4-diazabicyclo[2.2.2]octane (DABCO) or 1,8-diazabicyclo[5.4.0]undec-7-ene (DBU). To achieve thermal activation, particularly the tertiary amines, amidines or guanidines can reversibly form a salt or a complex with phenol or carboxylic acids, especially phenolic or other aromatic carboxylic acids, which is broken down when the temperature is increased.

The two-component polyurethane composition may contain, as well as the constituents already mentioned, further constituents as known to the person skilled in the art from two-component polyurethane chemistry, These may be present in just one component or in both.

Preferred further constituents are inorganic or organic fillers, such as, in particular, natural, ground or precipitated calcium carbonates, optionally coated with fatty acids, especially stearic acid, baryte (heavy spar), talcs, quartz flours, quartz sand, dolomites, wollastonites, kaolins, calcined kaolins, mica (potassium aluminum silicate), molecular sieves, aluminum oxides, aluminum hydroxides, magnesium hydroxide, silicas including finely divided silicas from pyrolysis processes, industrially produced carbon blacks, graphite, metal powders such as aluminum, copper, iron, silver or steel, PVC powder or hollow spheres.

It may be advantageous when the polyurethane composition comprises at least one filler selected from the group consisting of calcium carbonate, kaolin, baryte, talc, quartz flour, dolomite, wollastonite, kaolin, calcined kaolin and mica.

Further constituents present may especially also be solvents, plasticizers and/or extenders, pigments, rheology modifiers such as, in particular, amorphous hydrophobic silicas, desiccants such as, in particular, zeolites, adhesion promoters such as, in particular, trialkoxysilanes, stabilizers against oxidation, heat, light and UV radiation, flame-retardant substances, and surface-active substances, especially wetting agents and defoamers.

Components K1 and K2 are advantageously formulated such that the volume ratio of components K1 and K2 is between 1:3 and 3:1, especially between 1:2 and 2:1. This ratio is more preferably about 1:1.

A preferred two-component polyurethane composition consists of: a polyol component K1 containing, especially consisting of:
30% to 70% by weight, preferably 40% to 60% by weight, especially 45% to 55% by weight, of the sum total of (A1+A2+A3+A4+A5); and
20% to 60% by weight, preferably 30% to 50% by weight, especially 35% to 45% by weight, of fillers, especially fillers selected from the group consisting of calcium carbonate, kaolin, baryte, talc, quartz flour, dolomite, wollastonite, kaolin, calcined kaolin, and mica, more preferably calcium carbonate and rheology modifiers such as, in particular, hydrophobic amorphous silicas; and
0% to 5% by weight, preferably 1% to 4% by weight, especially preferably 2% to 4% by weight, of catalysts for the acceleration of the reaction of hydroxyl groups with isocyanate groups;
0% to 5% by weight, preferably 0.5% to 3% by weight, especially preferably 1% to 2% by weight, of desiccants (especially zeolites);
based on the total weight of the polyol component K1,

and of a polyisocyanate component K2 including:
a proportion of the aromatic polyisocyanurate B1 of ≥90% by weight, especially ≥95% by weight, especially preferably ≥99% by weight, based on the total weight of the polyisocyanate component K2.

The two components are produced separately from one another and, at least for the second component, preferably with exclusion of moisture. The two components are typically each stored in a separate container. The further constituents of the polyurethane composition may be present as a constituent of the first or second component, and further constituents that are reactive toward isocyanate groups are preferably a constituent of the first component. A suitable container for storage of the respective component is especially a vat, a hobbock, a bag, a bucket, a can, a cartridge or a tube. The components are both storage-stable, meaning that they can be stored prior to use for several months up to one year or longer, without any change in their respective properties to a degree of relevance to their use.

The two components are stored separately from one another prior to the mixing of the composition and are only mixed with one another on or immediately prior to use. They are advantageously present in a package consisting of two separate chambers.

In a further aspect, the invention comprises a pack consisting of package having two separate chambers which respectively contain the first component and the second component of the composition.

The mixing is typically effected via static mixers or with the aid of dynamic mixers. In the mixing, it should be ensured that the two components are mixed with maximum homogeneity. If the two components are mixed incompletely, local deviations from the advantageous mixing ratio will occur, which can result in a deterioration in the mechanical properties.

On contact of the first component with isocyanate groups of the second component, curing commences by chemical reaction. This involves reaction of the hydroxyl groups present and of any further substances reactive toward isocyanate groups that are present with isocyanate groups that are present. Excess isocyanate groups react with moisture present. As a result of these reactions, the polyurethane composition cures to give a solid material. This operation is also referred to as crosslinking.

The invention thus also further provides a cured polyurethane composition obtained from the curing of the polyurethane composition as described in the present document.

The two-component polyurethane composition described is advantageously usable as structural adhesive.

The invention thus also relates to a method of bonding a first substrate to a second substrate, comprising the steps of:
mixing the above-described polyol component K1 and polyisocyanate component K2,
applying the mixed polyurethane composition to at least one of the substrate surfaces to be bonded,
joining the substrates to be bonded within the open time,
curing the polyurethane composition.

These two substrates may consist of the same material or different materials.

In these methods of, suitable substrates are especially
glass, glass ceramic, glass mineral fiber mats;
metals and alloys such as aluminum, iron, steel and nonferrous metals, and also surface-finished metals and alloys such as galvanized or chromed metals;
coated and painted substrates, such as powder-coated metals or alloys and painted sheet metal;
plastics, such as polyvinyl chloride (rigid and flexible PVC), acrylonitrile-butadiene-styrene copolymers (ABS), polycarbonate (PC), polyamide (PA), poly(methyl methacrylate) (PMMA), polyester, epoxy resins, especially epoxy-based thermosets, polyurethanes (PUR), polyoxymethylene (POM), polyolefins (PO), polyethylene (PE) or polypropylene (PP), ethylene/propylene copolymers (EPM) and ethylene/propylene/diene terpolymers (EPDM), where the plastics may preferably have been surface-treated by means of plasma, corona or flames;
fiber-reinforced plastics, such as carbon fiber-reinforced plastics (CFP), glass fiber-reinforced plastics (GFP) and sheet molding compounds (SMC);
wood, woodbase materials bonded with resins, for example phenolic, melamine or epoxy resins, resin-textile composites and further polymer composites; and
concrete, mortar, brick, gypsum and natural stone such as granite, limestone, sandstone or marble.

In these methods, one of the two substrates is preferably a metal or a glass ceramic or a glass or a glass fiber-reinforced plastic or a carbon fiber-reinforced plastic or an epoxy-based thermoset.

The substrates can be pretreated if required prior to the application of the composition. Pretreatments of this kind especially include physical and/or chemical cleaning methods, and the application of an adhesion promoter, an adhesion promoter solution or a primer.

The method of bonding described gives rise to an article in which the composition joins two substrates to one another.

This article is especially a sandwich element of a lightweight structure, a built structure, for example a bridge, an industrial good or a consumer good, especially a window, a rotor blade of a wind turbine or a mode of transport, especially a vehicle, preferably an automobile, a bus, a truck, a rail vehicle or a ship, or else an aircraft or helicopter, or an installable component of such an article.

One feature of the two-component polyurethane composition described is that it has a minor dependence of mechanical properties, especially tensile strength and moduli of elasticity, on temperature. On account of these properties, it is very particularly suitable as structural adhesive for bonds that are subjected to stress outdoors at ambient temperatures.

The present invention thus also further provides for the use of the polyurethane composition described as structural adhesive for bonding of two substrates.

It has been found that, surprisingly, the compositions of the invention are particularly resistant to foaming as a result of the reaction of isocyanate with residual moisture remaining in the polyol component K1. Therefore, it is possible to dispense with drying, typically by means of reduced pressure, of the polyol component K1, which is a great advantage in terms of process technology. It may therefore be advantageous when no reduced pressure, especially of less than 200 mbar, especially of less than 100 mbar, especially of less than 50 mbar, preferably 20-5 mbar, is applied to the polyol component K1 for more than 10 min, especially more than 30 min, preferably for 30-120 min, within less than 1 day, preferably less than 5 h, prior to the mixing.

It has been found that, surprisingly, the compositions of the invention are particularly resistant to foaming as a result of a reaction of isocyanate groups with residual moisture remaining on the substrate. Therefore, when the compositions of the invention are used, it is possible to dispense with drying of the substrate, especially by heating and/or reduced pressure, which is a great advantage in terms of process technology.

It may further be advantageous when the substrates are not dried, especially not dried by applying reduced pressure, especially of less than 100 mbar, especially less than 50 mbar, preferably 20-1 mbar, for more than 60 min, especially more than 120 min, preferably for 1-12 h, especially preferably 2-8 h, and/or heating to a temperature above 50° C., especially about 55° C., more preferably to a temperature of 60-80° C., for more than 60 min, preferably more than 120 min, especially preferably for 1-12 h, especially preferably 2-8 h, within less than 24 h, preferably less than 12 h, especially less than 6 h, prior to the application of the mixed polyurethane composition onto the substrate.

In the case of prior art compositions, it may also be advantageous for an improvement in the properties of the crosslinked compositions to subject the bonded substrates to a heat treatment process after the composition has cured. Thus, on completion of crosslinking, the mechanical stability of the cured compositions under thermal stress can be improved.

It has been found that, surprisingly, in the case of the compositions of the invention, such heat treatment processes are not necessary for attainment of good mechanical properties (the values for 3 h at 80° C. are comparable to the values for 7 d at RT). The omission of time-consuming and energy-intensive heat treatment processes is a great advantage in terms of process technology.

It may further be advantageous when the bonded substrates after curing are not subjected to a heat treatment process, and is especially not brought to an elevated temperature between 40 and 90° C. for a period between 30 min-24 hours.

The invention also further provides a bonded article obtained from the method of the invention.

If the two-component polyurethane composition is used as adhesive, the cured composition preferably has the following properties (by the test methods/test conditions used in the examples section below, curing conditions 3 h at 80° C.):

| | |
|---|---|
| TS [MPa] | 7.3-23 |
| Modulus of elasticity 0.05-0.25% | 74-745 |
| [MPa] | |
| Modulus of elasticity 0.5-5% [MPa] | 54-392 |
| 1st Tg (° C.) | −60 to −58 |
| 2nd Tg (° C.) | 60-127 |

From table 5 it is apparent that polyurethane compositions containing no A5 exhibit low values of the modulus of elasticity. They also have a low temperature difference between the first and the second Tg. This is apparent in particular from comparative example R1.

From table 5 it is also apparent that polyurethane compositions containing no A1 exhibit low values of the tensile strength and of the modulus of elasticity. They also have a low temperature difference between the first and the second Tg. This is apparent in particular from comparative example R4.

From table 5 it is also apparent that polyurethane compositions containing no A4 have a low temperature difference between the first and the second Tg. In particular this leads to the loss of two different Tg values and hence to a so-called mixed Tg. This is disadvantageous in particular in that these polyurethane compositions exhibit no temperature independence of the mechanical properties, especially between −60° C. and 50° C. The compositions without A4 have a single mixed Tg at around 60° C. and consequently the mechanical properties above and below the broad mixed Tg are significantly different. This is a disadvantage in particular for use in applications which exhibit an application range of between −60° C. and 100° C. This is apparent in particular from the comparison of the two comparative examples R5 and R6.

### EXAMPLES

### Substances Used:

| | |
|---|---|
| Setathane 1150 | Reaction product of castor oil with ketone resin, |
| | Setathane ® 1150, OH number of 155 mg KOH/g, OH |
| | equivalent weight of about 360 g/eq, Nuplex Resins |
| | GmbH, Germany |
| Desmophen T | Propoxylated 1,1,1-trimethylolpropane, Desmophen ® |
| 4011 | 4011 T, OH number of 550 ± 25 mg KOH/g, average |
| | molecular weight of about 300 ± 20 g/mol, Covestro AG, |
| | Germany |
| Polybd 45 | Polybutadiene polyol having primary OH groups, OH |
| HTLO | functionality 2.4-2.6, average molecular weight about |
| | 2800 g/mol, OH number 47 mg KOH/g (Poly bd ® R- |
| | 45HTLO from Total Cray Valley, USA) |
| REAGEM | REAGEM 5006, OH number of 75 mg KOH/g, CAS |
| 5006 | number 92128-24-0, Granel S. A., France |
| Zr catalyst | Zirconium chelate complex, Zr content 3.5% by weight |
| | (K-Kat ® A-209 from King Industries Inc., USA) |
| Sylosiv | Zeolite (Sylosiv ® A3 from W. R. Grace & Co., USA) |
| Desmodur VL | Polymeric MDI, average NCO functionality of 2.5, |
| | Desmodur ® VL, Covestro AG, Germany |
| Isonate M 143 | Modified diphenylmethane diisocyanate containing MDI |
| | carbodiimide adducts, average NCO functionality of 2.2, |
| | NCO content 29.4% by weight, Isonate ® M 143 from |
| | Dow |
| Desmodur | Monomeric MDI, average NCO functionality of 2.0, |
| 44MC | Desmodur ® VL, Covestro AG, Germany |

Production of Polyurethane Compositions

For each composition, the ingredients specified in tables 1 to 5 were processed in the specified amounts (in parts by weight) of the polyol component K1 by means of a vacuum dissolver with exclusion of moisture to give a homogeneous paste, and stored. The ingredients of the polyisocyanate component K2 specified in tables 1 to 5 were likewise processed and stored. Subsequently, the two components were processed by means of a SpeedMixer® (DAC 150 FV, Hauschild) for 30 seconds to give a homogeneous paste and immediately tested as follows:

To determine the mechanical properties, the adhesive was converted to dumbbell form according to ISO 527, Part 2, 1B, and stored for 7 days under standard climatic conditions (23° C., 50% relative humidity) or stored under standard climatic conditions for 12-24 h and then cured for 3 h at 80° C. Thereafter, at room temperature, modulus of elasticity in the range from 0.05% to 0.2% elongation (“Modulus of elasticity”, “Em 0.05-0.25%”), modulus of elasticity in the range from 0.5% to 5% elongation (“Modulus of elasticity”, “Em 0.5-5%”), tensile strength (TS) and elongation at break (EB) of the test specimens thus produced were measured to ISO 527 on a Zwick Z020 tensile tester at a testing rate of 10 mm/min.

Glass transition temperature, abbreviated in the tables to T_{g}, was determined from DMTA measurements on strip samples (height 2-3 mm, width 2-3 mm, length 8.5 mm) which were stored/cured at 23° C. for 12-24 h and then at 80° C. for 3 h, with a Mettler DMA/SDTA 861e instrument. The measurement conditions were: measurement in tensile mode, excitation frequency 10 Hz and heating rate 5 K/min. The samples were cooled down to −70° C. and heated to 200° C. with determination of the complex modulus of elasticity E* [MPa], and a maximum in the curve for the loss angle “tan δ” was read off as T_{g}.

The results are reported in tables 1 to 5.

TABLE 1

| | OHN | E1 | E2 | E3 | E4 | E5 | E6 | E7 | E8 | E9 | E10 | E11 | E12 | E13 |
|---|---|---|---|---|---|---|---|---|---|---|---|---|---|---|
| Polyol comp. K1 | | | | | | | | | | | | | | |
| Reagem 5006 | 75 | 30 | 30 | 30 | 30 | 30 | 30 | 30 | 30 | 30 | 30 | 30 | 30 | 30 |
| (A5) | | | | | | | | | | | | | | |
| Setathane 1150 | 155 | 34 | 32 | 44 | 42 | 31 | 30 | 29 | 28 | 28 | 27 | 26 | 25 | 24 |
| (A1) | | | | | | | | | | | | | | |
| Polybutadiene 45 | 48 | 30 | 30 | 20 | 20 | 30 | 30 | 30 | 30 | 28 | 27 | 26 | 25 | 24 |
| HTLO (A4) | | | | | | | | | | | | | | |
| Desmophen | 550 | 4 | 4 | 4 | 4 | 4 | 4 | 4 | 4 | 4 | 4 | 4 | 4 | 4 |
| T 4011 (A2) | | | | | | | | | | | | | | |
| Butane-1,4-diol | 1245 | 0 | 2 | 0 | 2 | 3 | 4 | 5 | 6 | 8 | 10 | 12 | 14 | 16 |
| (A3) | | | | | | | | | | | | | | |
| Catalyst | | 0.1 | 0.1 | 0.1 | 0.1 | 0.1 | 0.1 | 0.1 | 0.1 | 0.06 | 0.06 | 0.06 | 0.06 | 0.06 |
| Sylosiv | | 2 | 2 | 2 | 2 | 2 | 2 | 2 | 2 | 2 | 2 | 2 | 2 | 2 |
| Polyisocyanate | | | | | | | | | | | | | | |
| comp. K2 | | | | | | | | | | | | | | |
| Desmodur VL | | 100 | 100 | 100 | 100 | 100 | 100 | 100 | 100 | 100 | 100 | 100 | 100 | 100 |
| Mixing ratio | | 27.9 | 33.4 | 30.6 | 36 | 36.2 | 38.8 | 41.6 | 44.2 | 50.4 | 56 | 61.8 | 67.4 | 73.2 |
| NCO/OH ratio | | 1.1 | 1.1 | 1.1 | 1.1 | 1.1 | 1.1 | 1.1 | 1.1 | 1.1 | 1.1 | 1.1 | 1.1 | 1.1 |
| (A1 + A4 + A5)/ | | 4.07 | 1.84 | 4.56 | 2.07 | 1.43 | 1.16 | 0.97 | 0.83 | 0.65 | 0.53 | 0.44 | 0.37 | 0.32 |
| (A2 + A3) | | | | | | | | | | | | | | |
| (A1 + A2 + | | — | 4.36 | — | 4.79 | 2.86 | 2.12 | 1.67 | 1.37 | 1.02 | 0.80 | 0.65 | 0.55 | 0.47 |
| A4 + A5)/(A3) | | | | | | | | | | | | | | |
| (A1 + A5)/(A4) | | 5.2 | 5.0 | 9.4 | 9.1 | 4.9 | 4.8 | 4.7 | 4.6 | 4.9 | 5.0 | 5.0 | 5.1 | 5.2 |
| Gelation time | | 53 | 14 | 47 | 16 | 12 | 10 | 7 | 8 | 9 | 7 | 7 | 8 | 6 |
| [min] | | | | | | | | | | | | | | |
| 3 h at 80° C. | | | | | | | | | | | | | | |
| TS [MPa] | | 9.7 | 12.4 | 12 | 13.7 | 10.6 | 12.7 | 13.9 | 13.2 | 14.1 | 14.7 | 12.9 | 12.1 | 11.8 |
| EB [%] | | 119 | 76 | 85 | 68 | 94 | 92 | 91 | 81 | 71 | 60 | 43 | 32 | 21 |
| Em0.05-0.25% | | 98 | 283 | 223 | 395 | 204 | 225 | 253 | 231 | 304 | 272 | 192 | 180 | 278 |
| [MPa] | | | | | | | | | | | | | | |
| Em 0.5-5% | | 58 | 174 | 133 | 240 | 91 | 115 | 129 | 130 | 162 | 151 | 105 | 99 | 155 |
| [MPa] | | | | | | | | | | | | | | |
| 1st Tg (° C.) | | −60 | −60 | −60 | −60 | −60 | −60 | −60 | −60 | −60 | −60 | −60 | −60 | −60 |
| 2nd Tg (° C.) | | 60 | 78 | 67 | 76 | 76 | 84 | 92 | 102 | 108 | 118 | 120 | 125 | 127 |
| 7 d RT | | | | | | | | | | | | | | |
| TS [MPa] | | | | | | | | | 13.6 | 13.6 | 14.1 | 11.8 | 10.4 | 10.7 |
| EB [%] | | | | | | | | | 92 | 70 | 61 | 43 | 31 | 22 |
| Em0.05-0.25% | | | | | | | | | 218 | 225 | 255 | 190 | 165 | 246 |
| [MPa] | | | | | | | | | | | | | | |
| Em 0.5-5% | | | | | | | | | 114 | 130 | 145 | 112 | 102 | 133 |
| [MPa] | | | | | | | | | | | | | | |

TABLE 2

| | OHN | E1 | E14 | E15 | E16 | E17 | E18 | E19 | E20 | E21 | E22 | E23 |
|---|---|---|---|---|---|---|---|---|---|---|---|---|
| Polyol comp. K1 | | | | | | | | | | | | |
| Reagem 5006 (A5) | 75 | 30 | 30 | 30 | 30 | 30 | 30 | 30 | 30 | 30 | 30 | 30 |
| Setathane 1150 (A1) | 155 | 34 | 32 | 31 | 30 | 29 | 28 | 28 | 27 | 26 | 25 | 24 |
| Polybutadiene 45 | 48 | 30 | 30 | 30 | 30 | 30 | 30 | 28 | 27 | 26 | 25 | 24 |
| HTLO (A4) | | | | | | | | | | | | |
| Desmophen T 4011 (A2) | 550 | 4 | 4 | 4 | 4 | 4 | 4 | 4 | 4 | 4 | 4 | 4 |
| Pentane-1,5-diol | 1077 | | 2 | 3 | 4 | 5 | 6 | 8 | 10 | 12 | 14 | 16 |
| Catalyst | | 0.1 | 0.1 | 0.1 | 0.1 | 0.1 | 0.1 | 0.06 | 0.06 | 0.06 | 0.06 | 0.06 |
| Sylosiv | | 2 | 2 | 2 | 2 | 2 | 2 | 2 | 2 | 2 | 2 | 2 |
| Polyisocyanate comp. K2 | | | | | | | | | | | | |
| Desmodur VL | | 100 | 100 | 100 | 100 | 100 | 100 | 100 | 100 | 100 | 100 | 100 |
| Mixing ratio | | 27.9 | 32.6 | 34.8 | 37.2 | 39.4 | 41.8 | 47 | 51.8 | 56.8 | 61.6 | 66.4 |
| NCO/OH ratio | | 1.1 | 1.1 | 1.1 | 1.1 | 1.1 | 1.1 | 1.1 | 1.1 | 1.1 | 1.1 | 1.1 |
| (A1 + A4 + A5)/ | | 4.07 | 1.99 | 1.56 | 1.28 | 1.08 | 0.93 | 0.73 | 0.60 | 0.50 | 0.42 | 0.37 |
| (A2 + A3) | | | | | | | | | | | | |
| (A1 + A2 + A4 + | | — | 5.04 | 3.31 | 2.45 | 1.93 | 1.58 | 1.18 | 0.92 | 0.75 | 0.63 | 0.54 |
| A5)/(A3) | | | | | | | | | | | | |
| (A1 + A5)/(A4) | | 5.2 | 5.0 | 4.9 | 4.8 | 4.7 | 4.6 | 4.9 | 5.0 | 5.0 | 5.1 | 5.2 |
| Gelation time [min] | | 53 | 17 | 15 | 11 | 7 | 8 | 8 | 7 | 6 | 6 | 6 |
| 3 h at 80° C. | | | | | | | | | | | | |
| TS [MPa] | | 9.7 | 9.6 | 11 | 12.2 | 12.8 | 12.9 | 13.1 | 11.5 | 9.6 | 7.5 | 7.3 |
| EB [%] | | 119 | 120 | 110 | 99 | 91 | 91 | 79 | 39 | 31 | 30 | 27 |
| Em0.05-0.25% [MPa] | | 98 | 125 | 153 | 221 | 251 | 258 | 329 | 332 | 217 | 74 | 87 |
| Em 0.5-5% [MPa] | | 58 | 48 | 81 | 106 | 123 | 127 | 161 | 183 | 121 | 47 | 54 |
| 1st Tg (° C.) | | −60 | −60 | −60 | −60 | −60 | −60 | −60 | −60 | −60 | −60 | −60 |
| 2nd Tg (° C.) | | 60 | 67 | 73 | 78 | 87 | 93 | 103 | 108 | 113 | 116 | 115 |
| 7 d RT | | | | | | | | | | | | |
| TS [MPa] | | | | | | | 11.9 | 13 | 10.7 | 7.3 | 6.4 | 7.2 |
| EB [%] | | | | | | | 92 | 70 | 20 | 20 | 29 | 25 |
| Em0.05-0.25% [MPa] | | | | | | | 262 | 358 | 354 | 197 | 51 | 118 |
| Em 0.5-5% [MPa] | | | | | | | 125 | 180 | 189 | 108 | 33 | 70 |

TABLE 3

| | OHN | E24 | E25 | E26 | E27 | E28 | E29 | E30 | E31 | E32 | E33 |
|---|---|---|---|---|---|---|---|---|---|---|---|
| Polyol comp. K1 | | | | | | | | | | | |
| Reagem 5006 (A5) | 75 | 30 | 30 | 30 | 30 | 30 | 30 | 30 | 30 | 30 | 30 |
| Setathane 1150 (A1) | 155 | 34 | 32 | 30 | 28 | 28 | 27 | 26 | 25 | 24 | 23 |
| Polybutadiene 45 HTLO (A4) | 48 | 30 | 30 | 30 | 30 | 28 | 27 | 26 | 25 | 24 | 23 |
| Desmophen T 4011 (A2) | 550 | 4 | 4 | 4 | 4 | 4 | 4 | 4 | 4 | 4 | 4 |
| Butane-1,4-diol (A3) | 1245 | 0 | 2 | 4 | 6 | 8 | 10 | 12 | 14 | 16 | 18 |
| Catalyst | | 0.1 | 0.1 | 0.1 | 0.1 | 0.06 | 0.06 | 0.06 | 0.06 | 0.06 | 0.06 |
| Sylosiv | | 2 | 2 | 2 | 2 | 2 | 2 | 2 | 2 | 2 | 2 |
| Polyisocyanate comp. K2 | | | | | | | | | | | |
| Isonate M143 | | 100 | 100 | 100 | 100 | 100 | 100 | 100 | 100 | 100 | 100 |
| Mixing ratio | | 33.4 | 36.3 | 42.3 | 48.2 | 54.7 | 60.9 | 67.2 | 73.4 | 79.6 | 85.2 |
| NCO/OH ratio | | 1.1 | 1.1 | 1.1 | 1.1 | 1.1 | 1.1 | 1.1 | 1.1 | 1.1 | 1.1 |
| (A1 + A4 + A5)/(A2 + A3) | | 4.07 | 1.84 | 1.16 | 0.83 | 0.65 | 0.53 | 0.44 | 0.37 | 0.32 | 0.28 |
| (A1 + A2 + A4 + A5)/(A3) | | — | 4.36 | 2.12 | 1.37 | 1.02 | 0.80 | 0.65 | 0.55 | 0.47 | 0.41 |
| (A1 + A5)/(A4) | | 5.2 | 5.0 | 4.8 | 4.6 | 4.9 | 5.0 | 5.0 | 5.1 | 5.2 | 5.3 |
| Gelation time [min] | | 11 | 9 | 7 | 5 | 4 | 6 | 3 | 3 | 3 | 2 |
| 3 h at 80° C. | | | | | | | | | | | |
| TS [MPa] | | 10.9 | 9.2 | 11.5 | 13.7 | 17 | 18.2 | 19.5 | 21.3 | 23 | 22.2 |
| EB [%] | | 128 | 108 | 86 | 80 | 89 | 88 | 79 | 71 | 69 | 34 |
| Em0.05-0.25% [MPa] | | 163 | 236 | 306 | 425 | 536 | 497 | 574 | 641 | 738 | 745 |
| Em 0.5-5% [MPa] | | 68 | 96 | 153 | 179 | 223 | 259 | 309 | 335 | 392 | 378 |
| 1st (° C.) | | −60 | −60 | −60 | −60 | −60 | −60 | −60 | −60 | −60 | −60 |
| 2nd Tg (° C.) | | 63 | 71 | 82 | 91 | 98 | 96 | 103 | 105 | 104 | 105 |
| 7 d RT | | | | | | | | | | | |
| TS [MPa] | | 9.8 | 8.6 | 10.5 | 12.8 | 15.4 | 15.6 | 16.3 | 18.2 | 20.4 | 18.7 |
| EB [%] | | 123 | 116 | 103 | 105 | 111 | 77 | 45 | 25 | 28 | 4 |
| Em0.05-0.25% [MPa] | | 110 | 162 | 294 | 372 | 432 | 514 | 597 | 668 | 761 | 751 |
| Em 0.5-5% [MPa] | | 57 | 80 | 141 | 172 | 208 | 251 | 295 | 329 | 380 | n.d. |

TABLE 4
highly exothermic reaction

| | OHN | E34 | E35 | E36 | E37 | E38 | E39 | E40 | E41 | E42 | E43 |
|---|---|---|---|---|---|---|---|---|---|---|---|
| Polyol comp. K1 | | | | | | | | | | | |
| Reagem 5006 (A5) | 75 | 30 | 30 | 30 | 30 | 30 | 30 | 30 | 30 | 30 | 30 |
| Setathane 1150 (A1) | 155 | 34 | 32 | 30 | 28 | 28 | 27 | 26 | 25 | 24 | 23 |
| Polybutadiene 45 HTLO (A4) | 48 | 30 | 30 | 30 | 30 | 28 | 27 | 26 | 25 | 24 | 23 |
| Desmophen T 4011 (A2) | 550 | 4 | 4 | 4 | 4 | 4 | 4 | 4 | 4 | 4 | 4 |
| Butane-1,4-diol (A3) | 1245 | 0 | 2 | 4 | 6 | 8 | 10 | 12 | 14 | 16 | 18 |
| Catalyst | | 0.1 | 0.1 | 0.1 | 0.1 | 0.06 | 0.06 | 0.06 | 0.06 | 0.06 | 0 |
| Sylosiv | | 2 | 2 | 2 | 2 | 2 | 2 | 2 | 2 | 2 | 2 |
| Polyisocyanate comp. K2 | | | | | | | | | | | |
| Desmodur 44MC | | 100 | 100 | 100 | 100 | 100 | 100 | 100 | 100 | 100 | 100 |
| Mixing ratio | | 26.6 | 31.8 | 37 | 42.2 | 47.9 | 53.3 | 58.8 | 64.2 | 69.7 | 75.1 |
| NCO/OH ratio | | 1.1 | 1.1 | 1.1 | 1.1 | 1.1 | 1.1 | 1.1 | 1.1 | 1.1 | 1.1 |
| (A1 + A4 + A5)/(A2 + A3) | | 4.07 | 1.84 | 1.16 | 0.83 | 0.65 | 0.53 | 0.44 | 0.37 | 0.32 | 0.28 |
| (A1 + A2 + A4 + A5)/(A3) | | — | 4.36 | 2.12 | 1.37 | 1.02 | 0.80 | 0.65 | 0.55 | 0.47 | 0.41 |
| (A1 + A5)/(A4) | | 5.2 | 5.0 | 4.8 | 4.6 | 4.9 | 5.0 | 5.0 | 5.1 | 5.2 | 5.3 |
| Gelation time [min] | | 16 | 8 | 7 | 5 | 4 | 4 | 3 | 3 | 2* | 4 |
| 3 h at 80° C. | | | | | | | | | | | |
| TS [MPa] | | 7.6 | 8.6 | 9.8 | 10.9 | 13.2 | 12 | 12.9 | 12.6 | 8.8 | 7.1 |
| EB [%] | | 162 | 120 | 116 | 103 | 90 | 57 | 36 | 12.1 | 5 | 6.8 |
| Em0.05-0.25% [MPa] | | 41 | 145 | 155 | 242 | 297 | 321 | 384 | 450 | 365 | 322 |
| Em 0.5-5% [MPa] | | 13.7 | 73 | 76 | 106 | 141 | 148 | 177 | 201 | 164 | 119 |
| 7 d RT | | | | | | | | | | | |
| TS [MPa] | | 7.9 | 8.6 | 10.3 | 10.4 | 12.4 | 11 | 13 | 12.3 | 9.2 | 7.8 |
| EB [%] | | 158 | 134 | 136 | 107 | 101 | 53 | 38 | 8 | 4 | 4 |
| Em0.05-0.25% [MPa] | | 57 | 137 | 156 | 239 | 289 | 322 | 426 | 461 | 422 | 382 |
| Em 0.5-5% [MPa] | | 15 | 66 | 74 | 95 | 135 | 142 | 191 | 211 | n.d. | 160 |
| 1st Tg (° C.) | | −60 | −60 | −60 | −60 | −60 | −60 | −60 | −60 | −60 | −60 |
| 2nd Tg (° C.) | | 55 | 65 | 66 | 68 | 72 | 74 | 76 | 78 | 82 | 78 |

TABLE 5

| | OHN | R1 | R2 | R3 | R4 | R5 | R6 |
|---|---|---|---|---|---|---|---|
| Polyol Comp. K1 | | | | | | | |
| Reagem 5006 (A5) | 75 | 0 | 98 | 94 | 64 | 30 | 30 |
| Setathane 1150 (A1) | 155 | 64 | 0 | 0 | 0 | 64 | 62 |
| Polybutadiene 45 HTLO (A4) | 48 | 32 | 0 | 0 | 30 | 0 | 0 |
| Desmophen T 4011 (A2) | 550 | 4 | 0 | 4 | 4 | 4 | 4 |
| Butane-1,4-diol (A3) | 1245 | 0 | 0 | 0 | 0 | 0 | 2 |
| Catalyst | | 0.3 | 0.1 | 0.1 | 0.1 | 0.1 | 0.1 |
| Sylosiv | | 2 | 2 | 2 | 2 | 2 | 2 |
| Polyisocyanate comp. K2 | | | | | | | |
| Desmodur VL | | 100 | 100 | 100 | 100 | 100 | 100 |
| Mixing ratio | | 34.4 | 18 | 22.7 | 21.1 | 35.9 | 41.4 |
| NCO/OH-ratio | | 1.1 | 1.1 | 1.1 | 1.1 | 1.1 | 1.1 |
| (A1 + A4 + A5)/(A2 + A3) | | 5.21 | — | 3.20 | 2.84 | 5.53 | 2.53 |
| (A1 + A2 + A4 + A5)/(A3) | | — | — | — | — | — | 5.65 |
| (A1 + A5)/(A4) | | 6.5 | — | — | 3.3 | — | — |
| Gelation time [min] | | 30 | 49 | 52 | 21 | 43 | 26 |
| 3 h at 80° C. | | | | | | | |
| TS [MPa] | | 9.5 | 3.8 | 6 | 4.6 | 12.6 | 12.3 |
| EB [%] | | 122.3 | 67 | 57 | 86 | 96 | 55 |
| Em0.05-0.25% [MPa] | | 32 | 20 | 65 | 16 | 139 | 352 |
| Em 0.5-5% [MPa] | | 7 | 13 | 40 | 11 | 74 | 192 |
| 1st Tg (° C.) | | −60 | −38 | −38 | −53 | | |
| 2nd Tg (° C.) | | 52 | 50 | 62 | 53 | 57 | 67 |
| 7 d RT | | | | | | | |
| TS [MPa] | | 7.76 | | | | | |
| EB [%] | | 101.1 | | | | | |
| Em0.05-0.25% [MPa] | | 15.4 | | | | | |
| Em 0.5-5% [MPa] | | 5 | | | | | |

Tables 1 to 5 specify the components of the polyol comp. K1, or of the polyisocyanate comp. K2, in parts by weight.

The figures (A1+A4+A5)/(A2+A3) and (A1+A2+A4+A5)/(A3) and also (A1+A5)/(A4) in tables 1 to 5 relate to the ratio of the OH groups of A1 Setathane 1150, A2 Desmophen T 4011, A3 aliphatic diol, A4 Polyvest HT and A5 Reagem 5006, respectively.

The term “NCO/OH ratio” indicates the ratio of all NCO groups of the aromatic polyisocyanates B1 to all OH groups of the sum total of (A1+A2+A3+A4+A5).

The term “Mixing ratio” indicates the proportion of component K2 in parts by weight that has been added to 100 parts by weight of the appropriate component K1.

The term “OHN” represents the hydroxyl number (OH number) of the polyols used.

“Gelation time [min]” as a measure of open time was determined the “tack-free time”. For this purpose, a few grams of the adhesive were applied to cardboard in a layer thickness of about 2 mm and, under standard climatic conditions, the time until, when the surface of the adhesive was gently tapped by means of an LDPE pipette, there were for the first time no residues remaining any longer on the pipette was determined.

E1 to E43 are inventive examples. R1 to R6 are comparative examples.

1. A two-component polyurethane composition consisting of a polyol component K1 and a polyisocyanate component K2;
wherein the polyol component K1 comprises
at least one reaction product of castor oil with ketone resins having an OH number of 110 to 200 mg KOH/g A1; and
at least one aliphatic triol having an average molecular weight of 170-500 g/mol and an OH number of 400-1100 mg KOH/g, which is polyether polyols based on 1,1,1-trimethylolpropane A2; and
optionally at least one aliphatic diol having a molecular weight of 90-146 g/mol A3; and
at least one polybutadiene polyol having an average OH functionality of 2.1 to 2.9, and having an average molecular weight in the range from 2000 to 4000 g/mol, and an OH number of 40-100 A4; and
at least one hydroxylated polyester polyol A5 based on tall oil;
and wherein the polyisocyanate component K2 comprises
at least one aromatic polyisocyanate B1,
where the ratio of the OH groups of (A1+A4+A5)/(A2+A3) is from 0.25-5;
and where the ratio of all NCO groups of the aromatic polyisocyanates B1:all OH groups of the polyol component K1=0.95:1-1.25:1.

2. The two-component polyurethane composition as claimed in claim 1, wherein the at least one aliphatic diol A3 is selected from the list consisting of butane-1,4-diol, 2-ethylhexane-1,3-diol, 3-methylpentane-1,5-diol and pentane-1,5-diol.

3. The two-component polyurethane composition as claimed in claim 1, wherein the ratio of all NCO groups of the aromatic polyisocyanates B1:all OH groups of the sum total of (A1+A2+A3+A4+A5)=0.95:1-1.25:1.

4. The two-component polyurethane composition as claimed in claim 1, wherein the ratio of the OH groups of (A1+A4+A5)/(A2+A3) is 0.3-1.4.

5. The two-component polyurethane composition as claimed in claim 1, wherein the ratio of the OH groups of (A1+A2+A4+A5)/(A3) is 0.4-5.

6. The two-component polyurethane composition as claimed in claim 1, wherein the ratio of the OH groups of (A1+A5)/(A4) is 2-15.

7. The two-component polyurethane composition as claimed in claim 1, wherein the sum total of all OH groups of (A1+A2+A3+A4+A5) is ≥90%, of the sum total of all OH groups of the two-component polyurethane composition.

8. The two-component polyurethane composition as claimed in claim 1, wherein the aromatic polyisocyanate B1 is monomeric MDI or oligomers, polymers and derivatives derived from MDI.

9. The two-component polyurethane composition as claimed in claim 1, wherein the aromatic polyisocyanate B1 is oligomers, polymers and derivatives derived from MDI.

10. The two-component polyurethane composition as claimed in claim 1, wherein the aromatic polyisocyanate B1 is polymers derived from MDI.

11. The two-component polyurethane composition as claimed in claim 1, wherein the sum total of the NCO groups that do not originate from B1 is ≤5%, based on the sum total of all NCO groups of the two-component polyurethane composition.

12. A method of bonding a first substrate to a second substrate, comprising the steps of:
mixing the polyol component (K1) and the polyisocyanate component (K2) of a two-component polyurethane composition as claimed in claim 1,
applying the mixed polyurethane composition to at least one of the substrate surfaces to be bonded,
joining the substrates to be bonded within the open time,
curing the polyurethane composition.

13. A bonded article obtained from a method as claimed in claim 12.

14. A method comprising bonding two substrates together, using a two-component polyurethane composition as claimed in claim 1 as structural adhesive.
